(19) United States
(12) Patent Application Publication
(10) Pub. No.: US 2008/0032025 A1
(43) Pub. Date: Feb. 7, 2008

(54) EFFERVESCENT CREAMER COMPOSITION

(75) Inventors: Brandon S. Fream, Blaine, MN (US); Andrea L. Berg, Minneapolis, MN (US); Mary Aldritt, Excelsior, MN (US); Robert E. Lee, Saint Louis Park, MN (US)

Correspondence Address: ALLISON JOHNSON, P.A., LAKE CALHOUN EXECUTIVE CENTER, 3033 EXCELSIOR BLVD., SUITE 467, MINNEAPOLIS, MN, 55416, US

(73) Assignee: AMERILAB TECHNOLOGIES, INC., Plymouth, MN (US)

(21) Appl. No.: 11/419,677

(22) Filed: May 22, 2006

(51) Int. Cl. A23L 2/40

(52) U.S. Cl. 426/561

(57) ABSTRACT

The effervescent creamer composition includes an effervescent agent comprising an acid and a base, a pH moderator, protein, a mouthfeel agent, a binder, and a lubricant.

### BACKGROUND

The invention relates to enhancing the flavor and mouthfeel of a beverage.

For years people have been adding cream to coffee to reduce the bitterness of coffee and to enhance its taste, flavor, and mouthfeel. Although cream is tasty, it can spoil easily and has some properties that tend to negatively impact the health of consumers including high fat content and high cholesterol content. In addition, many people have allergies to one or more components of cream or milk based-products. These factors have led to the development of powdered creamers.

For consumer appeal, the dry creamer should impart properties to the coffee similar to those properties imparted by adding milk or cream including a pleasing aroma, taste, rich creamy mouthfeel, and whitened appearance. Dry creamers also should readily disperse and preferably dissolve in the acidic environment of coffee.

Some consumers also prefer a dry creamer that creates foam at the surface of the coffee such as the foam present in a cafe latte. A latte foam should persist at the surface for a sufficient period of time and exhibit an aesthetically pleasing color. In addition, a latte foam preferably is made up of relatively small bubbles. These are properties that are difficult to achieve with a dry creamer. Some dry creamer compositions achieve a foam by including pockets of gas in the powder particles of the creamer. Quite often the foam produced by powdered creamers is minimal and quickly dissipates. The problem is exacerbated in formulating non-dairy creamers because the cream in dairy based creamers is the component responsible for producing the foam. In addition, some of the components that produce one of the characteristics desirable in a foamed coffee drink, tend to negatively influence another characteristic.

It is also desirable to provide creamers in a form that is easy to use and transport. It would be desirable to provide the creamer in a tablet form. However, many factors impact the ability to tablet a composition and to tablet a composition in a continuous operation. The composition must be able to flow through the tableting process, be tableted to a hardness sufficient to enable the tablet to maintain its integrity during packaging and transportation, and disintegrate or dissolve in an aqueous liquid.

### SUMMARY

In one aspect, the invention features an effervescent creamer composition that includes an effervescent agent that includes an acid and a base, a pH moderator, protein, a mouthfeel agent, binder, and lubricant.

In one embodiment, the protein includes soy protein and the composition is free from lactose, casein and caseinate. In some embodiments, the composition further includes titanium dioxide, polyethylene glycol, and xanthan gum. In other embodiments, the pH moderator includes diabasic potassium phosphate. In another embodiment, the composition further includes at least one of maltodextrin and corn syrup solids. In some embodiments, the effervescent composition includes from about 0.1% by weight to about 10% by weight the soy protein. In another embodiment, the effervescent composition further includes from about 0.5% by weight to about 10% by weight maltodextrin. In other embodiments, the effervescent composition further includes from about 1% by weight to about 10% by weight corn syrup solids.

In some embodiments, the protein includes at least one of whey protein, milk-based protein, casein and caseinate, and the composition further includes lecithin, corn syrup solids, emulsifier, surfactant, oil, and titanium dioxide. In one embodiment, the effervescent creamer composition further includes at least one of monoglycerides and triglycerides, sodium stearolyl lactylate, and xanthan gum.

In some embodiment, the effervescent composition further includes at least one of compressible sorbitol and crystalline sorbitol. In another embodiment, the effervescent composition further includes from about 2% by weight to about 25% by weight crystalline sorbitol. In other embodiments, the effervescent composition further includes from about 5% by weight to about 25% by weight compressible sorbitol.

In some embodiments, the effervescent composition further includes titanium dioxide. In another embodiment, the effervescent composition further includes from about 0.01% by weight to 5% by weight titanium dioxide.

In other embodiments, the effervescent composition further includes lecithin.

In some embodiments, the effervescent composition further includes polyethylene glycol. In another embodiment, the effervescent composition further includes from about 0.5% by weight to about 10% by weight polyethylene glycol.

In other embodiments, the effervescent composition the pH moderator includes diabasic potassium phosphate. In some embodiments, the effervescent composition includes from about 0.01% by weight to about 4% by weight the dibasic potassium phosphate.

In another embodiment, the effervescent composition further includes from about 1% by weight to about 20% by weight compressible sorbitol, from about 2% by weight to about 20% by weight crystalline sorbitol, and lecithin.

In other embodiments, the effervescent composition further includes xanthan gum. In some embodiments, the effervescent composition further includes from about 0.5% by weight to about 5% by weight xanthan gum.

In another embodiment, the effervescent composition further includes a flavor agent. In other embodiments, the effervescent composition the flavor agent includes a flavor agent in the form of a flavor oil.

In some embodiments, the effervescent composition the flavor agent imparts a flavor selected from the group consisting of chocolate, hazelnut, maple, vanilla, almond, anise, caramel, cram and combinations thereof.

In another embodiment, the effervescent composition further includes from about 0.1% by weight to about 10% by weight lecithin.

In other embodiments, the effervescent composition includes from about 0.01% by weight to about 15% by weight the mouthfeel agent. In some embodiments, the effervescent composition the mouthfeel agent reduces metallic aftertastes. In another embodiment, the effervescent composition the mouthfeel agent enhances creaminess perception.

In other embodiments, the effervescent composition further includes oil.

In some embodiments, the effervescent composition further includes maltodextrin, corn syrup solids, from about 1% by weight to about 20% by weight compressible sorbitol, and from about 2% by weight to about 20% by weight crystalline sorbitol.

In some embodiments, effervescent creamer composition disclosed herein disintegrates when added to eight ounces of coffee having a temperature of at least 80° F. forms a foam on the surface thereof. In other embodiments, the foam persists for at least 3 minutes. In another embodiment, the effervescent creamer composition disintegrates when added to eight ounces of coffee having a temperature of at least 80° F. and whitens the coffee.

In another embodiment, an effervescent creamer composition disclosed herein is in the form of a tablet having a hardness of in at least 4 kilopounds and a weight from about 3.5 g to about 6 g. In other embodiments, the tablet further includes from about 20 mg to about 500 mg titanium dioxide. In other embodiments, the tablet further includes from about 25 mg to about 200 mg soy protein. In another embodiment, the tablet further includes from about 5 mg to about 30 mg lecithin. In some embodiments, the tablet further includes from about 1 mg to about 1000 mg crystalline sorbitol. In other embodimets, the tablet further includes from about 200 mg to about 700 mg crystalline sorbitol. In one embodiment, the tablet disintegrates when added to eight ounces of coffee having a temperature of at least 80° F. and forms a foam on the surface thereof. In some embodiments, the form persists for at least 3 minutes.

In one embodiment, the pH moderator includes from about 30 mg about 75 mg diabasic potassium phosphate, the protein includes from about 20 mg to about 80 mg soy protein, and the effervescent composition further includes from about 300 mg to about 900 mg compressible sorbitol, from about 300 mg to about 900 mg crystalline sorbitol, and from about 5 mg to about 50 lecithin.

In another aspect, the invention features a method of making a beverage that includes contacting an effervescent creamer composition disclosed herein with coffee having a temperature of at least 80° F. In one embodiment, the method further includes disintegrating the effervescent creamer composition and forming a foam on the coffee. In some embodiments, the method further includes disintegrating the effervescent creamer composition, and whitening the coffee.

In other embodiment, the method further includes disintegrating the effervescent creamer composition, and imparting a hazelnut flavor and aroma to the coffee.

The invention features effervescent creamers including dairy and non-dairy creamers. The invention features creamers that impart a creamy mouthfeel to a heated beverage such as coffee, and improve the bitter aftertaste of coffee. The invention also features creamers that whiten the color of the coffee to a lighter brown color or even a dark cream color and that provide a persistent foam that has properties of density and bubble size that are similar to that of a café latte-type foam on the surface of the cup of coffee. The foam exhibits a light brown to dark cream color. The creamers can be in the form of a convenient, easy to use effervescent tablet or effervescent powder.

Other features and advantages will be apparent from the following description of the preferred embodiments and from the claims.

### Glossary

In reference to the invention, these terms have the meanings set forth below:

The term “coffee” refers to a liquid beverage that is made from coffee beans and hot water.

The term “mouthfeel” refers in the sensation experienced by the surfaces of the mouth, and in particular the tongue, of a container.

The term “mouthfeel agent” refers to an agent that impacts the sensation experienced by the surfaces of the mouth, and in particular the tongue, of a consumer in a positive manner.

The term “pH moderator” refers to a component that alters the pH of an aqueous-based composition in which it is placed towards neutral, i.e., pH 7. The term “pH moderator” does not refer to the effervescent agent or a component of an acid base pair of the effervescent agent.

The term “non-dairy” means being free of components derived from milk.

### DETAILED DESCRIPTION

The effervescent creamer composition includes an effervescent agent that includes an acid and a base pair, a pH moderator, a mouthfeel agent, a protein, binder, and lubricant. The effervescent creamer composition enhances the flavor of, and imparts a creamy mouthfeel to, a beverage (e.g., coffee and tea) exhibiting a temperature of from about 100° F. (37.8° C.) to about 150° F. (65.6° C.)). The effervescent creamer composition can also be formulated to whiten a heated beverage, to provide a persistent foam on a heated beverage, and combinations thereof. For ease of discussion, the effervescent creamer composition will be discussed with respect to its use and impact on hot coffee although it is useful in other beverages including, e.g., tea, cocoa, and water.

Without being bound by theory, the present inventors believe that the improvement in taste and mouthfeel results from a combination of a pH moderator, which assists in reducing the bitter taste of coffee, and at least one mouthfeel agent that imparts a creamy taste experience to the consumer's tongue and mouth.

The acidic nature of coffee causes it to have a bitter taste to the consumer. The pH moderator raises the pH of acidic coffee, preferably to a neutral pH, i.e., pH 7, or even from about pH 6.5 to about pH 7.5, or even from about pH 6.7 to about pH 7.2. The pH moderator is preferably dibasic potassium phosphate. Another example of a useful pH moderator is trisodium citrate.

The mouthfeel agent preferably imparts a creamy taste sensation to the beverage as experienced by the consumer. The mouthfeel agent can be a single component or a combination of components. A useful mouthfeel agent that imparts creaminess is commercially available under the MAG-NIFIQUE MOUTHFEEL trade designation from Wixon, Inc. (St. Francis, Wis.). Other useful mouthfeel agents that impart creaminess include, e.g., corn syrup solids, maltodextrin, oils (e.g., vegetable oil), xanthan gum, gellan gum, carageenan gum, corn starch, and combinations thereof.

Maltodextrin is optionally present in the effervescent creamer composition in an amount of at least about 0.5% by weight, at least about 2% by weight at least about 5% by weight no greater than about 10% by weight, or even from about 0.5% by weight to about 10% by weight.

Corn syrup solids are optionally present in the composition in an amount of at least 1% by weight, at least about 3% by weight, no greater than about 10% by weight, or even from about 1% by weight to about 10% by weight.

Other useful mouthfeel agents reduce at least one aftertaste experienced by a consumer including, e.g., the metallic and chalky aftertastes that are often imparted by minerals, bitter aftertastes, and background bitter notes (i.e., an unpleasant taste sensation that does not fit with a desired collection of flavor, sweetness, and sourness). A useful mouthfeel agent that reduces metallic and chalky aftertastes is available under the MAG-NIFIQUE MINER trade designation from Wixon, Inc. (St. Francis, Wis.). Useful mouthfeel agents that mask or reduce bitter aftertastes and background bitter notes are available under the MAG-NIFIQUE BITTERLESS and MAG-NIFIQUE MASK trade designations from Wixon, Inc.

Mouthfeel agents are preferably present in the composition in an amount of at least about 0.5% by weight, at least about 2% by weight, at least about 5% by weight, no greater than about 10% by weight, or even from about 0.5% by weight to about 10% by weight.

The effervescent composition preferably is formulated to form foam at the surface of the beverage. The foam generated by the effervescent composition preferably exhibits bubble and density properties similar to a café latte prepared using a turbulent forced spray of steam and air. The foam generated by the effervescent composition preferably sits on the surface of the coffee preferably at a height of at least about 0.5 mm, at least about 2 mm, at least about 4 mm, or even no greater than about 10 mm, includes relatively small bubbles, is light brown, to dark cream to cream or even white in color, and is persistent. Preferably that foam persists over the period the beverage is consumed, prior to the consumption of a major portion of the beverage, for at least about 3 minutes, for at least about 5 minutes, or even for at least about 10 minutes, which time includes the time over which the foam is generated.

Protein contributes to the formation of foam during effervescence, i.e., the period during which gas is evolved from the effervescent agent. Protein is preferably present in the effervescent composition in an amount sufficient to assist in forming a foam having the desired properties over the desired period. Useful classes of proteins include, e.g., vegetable proteins (e.g., soy protein), milk-based proteins, e.g., whey proteins and casein, and salts thereof including, e.g., potassium caseinate, magnesium caseinate, calcium caseinate, ammonium caseinate, and combinations thereof. In the case of a non-dairy effervescent creamer composition, the protein source is a non-dairy protein source such as soy protein. Useful sources of soy protein include soy protein available under the trade designation SUPRO-XT 40 isolated dried soy protein product and FP 940 functional soy protein from The Solae Company (St. Louis, Mo.). Useful sources of milk-based proteins included powdered milk, powdered cream, and combinations thereof. A useful source of casein includes sodium caseinate (e.g., extruded sodium caseinate). The effervescent composition preferably includes protein in an amount of at least 0.1% by weight, at least about 1% by weight, at least about 2% by weight, at least about 5% by weight, no greater than about 15% by weight, or even no greater than about 10% by weight.

The effervescent composition optionally includes other components that contribute to foaming including, e.g., other proteins, xanthan gum, gellan gum, carageenan gum, and combinations thereof.

The effervescent composition can optionally include other suitable thickening agents. Xanthan gum is also an example of a suitable thickening agent. Suitable commercially available sources of xanthan gum are available under the KELTROL trade designation from CP Kelco (Atlanta, Ga.). Preferably the xanthan gum is present in the effervescent composition in an amount of at least about 0.5% by weight, at least about 1% by weight, at least about 2% by weight, or even no greater than about 5% by weight.

The composition preferably also includes lecithin. The lecithin can be derived from a variety of sources including, e.g., soy (e.g., soy beans, soy bean oil) and eggs. Soy lecithin is preferably in the form of sharp flakes or chunks. Lecithin preferably is present in the effervescent composition in an amount of no greater than about 10% by weight, no greater than about 1.5% by weight, no greater than about 1% by weight, no greater than about 0.5% by weight, at least about 0.1% by weight, or even from about 0.1% by weight to about 10% by weight.

The effervescent composition optionally includes a whitening agent. The preferred whitening agent is titanium dioxide. Titanium dioxide can be provided in a variety of forms including, e.g., neat (i.e., 100% pure), on a carrier and combinations thereof. A useful example of a carrier for the titanium dioxide is maltodextrin. Suitable commercially available sources of titanium dioxide include 25% titanium dioxide from Food Ingredient Solutions LLC (Wauwatosa, Wis.) and KOWET titanium dioxide from Kemira Chemicals Inc. (Kennesaw, Ga.). Preferably the titanium dioxide is present in the composition in an amount and in a form sufficient to visible whiten a cup of coffee (i.e., to cause a change in the color of the coffee to a lighter color including, e.g., light brown, creamy brown, dark cream or even white), in an amount of at least 0.5% by weight, at least 1% by weight, from about 0.5% by weight to about 10% by weight or even from about 0.5% by weight to about 5% by weight.

The effervescent composition can optionally include an emulsifier. Examples of useful emulsifiers include sodium stearoyl lactylate, monoglycerides, diglycerides, POLYSORBATE 80, and combinations thereof. When present, the composition preferably includes emulsifier in an amount of no greater than about 10% by weight, at least 0.5% by weight, at least about 1% by weight, no greater than about 7% by weight, or even no greater than about 5% by weight.

The effervescent composition can optionally include oil, useful examples of which include vegetable oil, mineral oil, fruit oil (e.g., oil from seeds), and combinations thereof. Examples of useful oils include corn oil, canola oil, flax seed oil, and nut oils (e.g., hazelnut oil, almond oil, peanut oil). When present, the composition preferably includes oil in an amount of no greater than about 5% by weight, at least 0.1% by weight, at least 0.5% by weight, no greater than about 2% by weight, or even no greater than about 1% by weight.

The effervescent composition preferably includes a flavor agent. Useful flavor agents include natural and artificial flavor agents including, e.g., volatile oils, synthetic flavor oils, flavoring aromatics, oils, liquids, oleoresins and extracts derived from plants (e.g., dry powder extracts and liquid extracts), leaves, flowers, fruits, stems and combinations thereof. Preferred flavor agents are flavor keys. Flavor keys are highly concentrated oil-based sources of flavor. Preferably the flavor agent is provided in a highly concentrated form having a purity of at least 85%, at least 90%, at least 95%, or even at least 98%. The composition can include any suitable flavor including, e.g., hazelnut, maple, vanilla, almond, anise, caramel, chocolate, cream, coffee roasts, and combinations thereof. The flavor agent is preferably present in the composition in an amount sufficient to impart a detectable flavor to a beverage. The amount of flavor agent will depend upon the concentration of the flavor agent prior to addition and any carrier present in the flavor agent. The flavor agent is preferably present in the effervescent creamer composition in an amount sufficient to impart the desired flavor to an eight ounce cup of coffee, in an amount of at least about 0.2% by weight, at least about 1% by weight, at least about 2% by weight, no greater than 20% by weight, no greater than 10% by weight, or even no greater than 5% by weight flavor agent.

The effervescent composition can also optionally include silica including, e.g., fumed silica (e.g. hydrophilic silica) and colloidal silica. Silica is preferably present in the effervescent composition in an amount sufficient to assist in or improve the flow of the effervescent composition from a mixing apparatus to a tableting press. Preferably silica is present in the composition in an amount of from 0% by weight to about 2.5% by weight or even from about 0.5% to about 2% by weight.

The effervescent agent is a component that is activated when contacted with an aqueous-based liquid (e.g., when the effervescent agent is placed in a container that includes the aqueous-based liquid) including, e.g., water, coffee, and tea. The water liberates the acid and base and enables the acid and base to react with each other to produce carbon dioxide gas, which can assist in forming foam. Examples of useful acids include citric acid, ascorbic acid, aspartic acid, malic acid, adipic acid, tartaric acid, fumaric acid, succinic acid, sodium acid pyrophosphate, lactic acid, hexamic acid, amino acids, and acid salts and acid anhydrides thereof, and mixtures thereof. Examples of useful acid anhydrides include citraconic anhydride, glucono-D-lactone, and succinic anhydride. Examples of useful acid salts include potassium bitartrate, acid citrate salts, sodium dihydrogen phosphate, disodium dihydrogen phosphate, sodium acid sulfite, and combinations thereof. Preferably acid is present in the composition in an amount from about 5% by weight to about 60% by weight, from about 10% by weight to about 50% by weight, or even from about 10% by weight to about 40% by weight.

The base preferably is capable of generating a gas such as carbon dioxide. Examples of suitable carbonate bases include sodium bicarbonate, sodium carbonate, sodium sesquicarbonate, potassium carbonate, potassium bicarbonate, calcium carbonate, magnesium carbonate, sodium glycine carbonate, L-lysine carbonate, arginine carbonate, zinc carbonate, amino acid carbonates, and mixtures thereof. The composition preferably includes base in an amount of from about 5% by weight to about 60% by weight, from about 10% by weight to about 50% by weight, or even from about 10% by weight to about 40% by weight.

The effervescent composition can optionally include desiccant. One example of a useful desiccant is sodium carbonate.

When in the form of a tablet, the effervescent composition preferably also includes binder, lubricant, and combinations thereof. Examples of suitable binders include, e.g., starches, natural gums, cellulose gums, microcrystalline cellulose, methylecellulose, cellulose ethers, sodium carboxymethylcellulose, ethylcellulose, gelatin, dextrose, lactose, sucrose, sorbitol, mannitol, polyethylene glycol, polyvinylpyrrolidone, pectins, alginates, polyacrylamides, polyvinyloxaozolidone, polyvinylalcohols and mixtures thereof. The xanthan gum, maltodextrin, and corn syrup solids described above can also function as a binder. Preferred binders are water soluble.

A particularly useful binder is sorbitol. Sorbitol is available in a variety of forms including, e.g., crystalline sorbitol and directly compressible sorbitol. Crystalline sorbitol is generally available as a fine powder having a smaller average particle size relative to directly compressible sorbitol. Directly compressible sorbitol is a form of sorbitol that can be compressed, e.g., into a tablet, and is described in some literature sources as being an interwoven, filamentary microstructure crystal form of sorbitol that has a granular macrostructure. Useful sources of sorbitol include spray dried free flowing compressible sorbitol powders available under the PARTECK SI series of trade designations including PARTECK SI 450, 400, 400 LEX, 150, 200, and 500 and SORBITOL INSTANT compressible sorbitol all of which are commercially available from EMD Chemicals Inc. (Gibbstown, N.J.), and SORBOGEM crystalline sorbitol from SPI Pharma (New Castle, Del.). The composition preferably includes crystalline sorbitol in an amount of at least about 7% by weight, at least about 10% by weight, from about 10% by weight to 25%by weight, or even from about 10% by weight to about 20% by weight. The effervescent composition preferably includes crystalline sorbitol in an amount of from 0% by weight to about 25% by weight, from about 5% by weight to about 25% by weight, or even from about 8% weight to about 20% by weight.

The effervescent composition preferably includes an amount of binder sufficient to assist in holding the components of the effervescent composition together in the form of a tablet, preferably from about 10% by weight to about 60% by weight, from about 10% by weight to about 50% by weight, from about 15% by weight to about 40% by weight, or even from about 20% by weight to about 30% by weight.

Various lubricants are suitable for use in the effervescent composition including water dispersible, water soluble, water insoluble lubricants and combinations thereof. Preferred lubricants are water soluble. Some lubricants also provide a binder function and vice versa. Examples of useful water soluble lubricants include sodium benzoate, polyethylene glycol, L-leucine, adipic acid, and combinations thereof. The effervescent composition optionally includes water insoluble lubricants including, e.g., stearates, calcium stearate and zinc stearate), oils (e.g., mineral oil, vegetable oil (e.g., hydrogenated and partially hydrogenated vegetable oils), and cotton seed oil) and combinations thereof. Other water insoluble lubricants include, e.g., animal fats, polyoxyethylene monostearate, tale, and combinations thereof. The effervescent composition preferably includes a sufficient amount of lubricant to enable the composition to be formed into tablets and released from a high speed tableting press in the form of a tablet; preferably the composition includes at least about 0.5% by weight, from about 1% by weight to about 15% by weight, from about 1% by weight to about 12% by weight, from about 2% by weight to about 10% by weight, or even from about 3% by weight to about 8% by weight lubricant.

The effervescent composition can optionally include a variety of other ingredients including, e.g., fillers, surfactants (e.g., cationic, nonionic and anionic surfactants including, e.g., polyoxyethylene fatty acid ester nonionic surfactants (e.g., POLYSORBATE 80 polyoxyethylene (20) sorbitan monooleate and sodium lauryl sulfate) and lecithin, color agents including, e.g., dyes and pigments, and sweeteners.

Useful sweetening agents include, e.g., stevia, sugars such as sucrose glucose, invert sugar, fructose, ribose, tagalose, sucralose, malitol, crythritol, xylitol, and mixtures thereof, saccharin and its various salts (e.g., odium and calcium salt of saccharin), cyclamic acid and its various salts, dipeptide sweeteners (e.g., aspartame and neotame (N-[N-(3,3-dimethylbutyl)-L-alpha-aspartyl]-L-phenylalanine-1-methyl ester), acesulfame potassium, dihydrochalcone, glycyrrhizin, and sugar alcohols including, e.g., sorbitol, sorbitol syrup, mannitol and xylitol, sucralose, and combinations thereof. Preferably the effervescent composition includes no greater than 5% by weight, at least about 0.1% by weight, at least about 0.3% by weight, no greater than about 1% by weight, or even no greater than about 0.8% by weight sweetening agent.

The solid components of the effervescent composition are preferably dried and sieved, where appropriate, prior to formulating.

The effervescent composition is preferably pressed into tablets having a hardness of at least 3 kilopounds (Kp), preferably at least about 4 Kp, from about 5 Kp to about 20 Kp, from about 5 Kp to 10 Kp, or even from about 5 Kp to about 8 Kp, as measured on a standard hardness tester fitted with a strain gauge.

The effervescent composition is well suited to the mass production of effervescent tablets that are free from picking, die wall etching, capping and lamination. Any suitable tablet mass production equipment and processes can be used. Examples of useful tableting processes for effervescent compositions are described in Pharmaceutical Dosage Forms: Tablets, Volume 1, Lieberman, 2^{nd} ed. 1989.

The effervescent composition can be formed into tablets in an automated process in which multiple dies of a tablet press are filled sequentially or simultaneously with the effervescent composition, two punches compress the effervescent composition to form the tablet(s), and then the tablet(s) is ejected from the die. The tablet is then placed in packaging material, which is then scaled to form an air tight sealed package. The packaged tablet can be further processed by conveying it to other processing stations including, e.g., additional packaging stations for further packaging, e.g., boxing and bagging.

The tablet manufacturing and initial packing operations are preferably preformed in a controlled environment in which the temperature and humidity are controlled. Preferably the controlled environment has less then 18 grains, less than 16 grains, or even less than 15 grains of moisture.

A particularly useful non-dairy effervescent creamer tablet has a weight of from about 3.5 grams to about 6 grams and includes

an effervescent agent (from about 1500 mg to about 2000 mg),

soy protein (at least about 20 mg, no greater than about 200 mg, from about 25 mg to about 200 mg or even from about 20 mg to about 80 mg),

pH moderator (at least about 30 mg, no greater than about 100 mg or even no greater than about 75 mg),

mouthfeel agent (from about 10 mg to about 100 mg),

polyethylene glycol (from about 0 mg to about 200 mg, from about 30 mg to about 200 mg, or even from about 30 mg to about 100 mg),

silica (from about 0 mg to about 80 mg),

xanthan gum (from about 50 mg to about 150 mg),

binder (from about 400 mg to about 1000 mg),

lubricant (from about 25 mg to about 80 mg),

titanium dioxide (from about 0 mg to about 500 mg, from about 20 mg to about 500 mg, or even from about 25 mg to about 100 mg),

lecithin (from about 10 mg to about 50 mg, from about 15 mg to about 30 mg or even from about 5 mg to about 30 mg),

crystalline sorbitol (from about 1mg to about 1000 mg, at least about 200 mg, at least about 300 mg, at least about 500 mg, no greater than about 900 mg, or even from about 200 mg to about 700 mg), and

compressible sorbitol (from about 1 mg to about 900 mg, at least about 300 mg, at least about 500 mg, no greater than about 900 mg, or even from about 300 mg to about 700 mg).

A particularly useful effervescent dairy creamer tablet formulation has a weight of from about 2.5 grams to about 6 grams and includes

an effervescent agent (from about 1000 mg to about 2500 mg),

protein (from about 25 mg to about 400 mg, or even from about 150 mg to about 250 mg),

pH moderator (from about 30 mg to about 100 mg, from about 40 mg to about 80 mg, or even no from about 45 mg to about 75 mg)

mouthfeel agent (from about 5 mg to about 25 mg),

xanthan gum (from about 50 mg to about 150 mg),

binder (from about 400 mg to about 1000 mg),

lubricant (from about 25 mg to about 100 mg),

titanium dioxide (from about 0 mg to about 500 mg, from about 20 mg to about 500 mg, or even from about 60 mg to about 110 mg),

lecithin (from about 5 mg to about 50 mg, or even from about 10 mg to about 30

compressible sorbitol (from about 50 mg to about 1000 mg, at least about 300 mg, at least about 500 mg, no greater than about 800 mg, or even from about 450 mg to about 750 mg),

emulsifier (from about 50 mg to about 300 mg or even from about 100 mg to about 200 mg), and

desiceant (from about 50 mg to about 300 mg or even from about 50 mg to about 200 mg).

Packaging for the effervescent composition is preferably moisture-proof, light impermeable or a combination thereof. Examples of useful forms of packaging include sealed metal foil pouches, blister packs, and desiceant capped tubes. Useful packaging materials further include metal foil, plastic films, and blister packaging.

A useful method of using the effervescent composition includes adding the effervescent composition to a hot coffee beverage, e.g., an ten ounce cup of coffee, allowing the effervescent agent to react and form a foam on the surface of the coffee. After addition of the effervescent composition to the hot coffee, the resulting composition optionally can be stirred to facilitate dispersion and/or dissolution of the tablet. The tablets preferably disintegrate, or even dissolve, in coffee having a temperature of about 120° F. in less than about 3 minutes, in less than about 2.5 minutes, or event in no greater than about 2 minutes.

The invention will now be described by way of the following examples.

### EXAMPLES

### Test Procedures

Test procedures used in the examples include the following.

### Example 1

### (Base)

The following ingredients were individually sieved through a number 12 sieve and then combined with mixing for 200 revolutions using a KITCHEN AID mixer: 700 mg granular citric acid, 600 mg sodium bicarbonate no. 5, 550 mg calcium carbonate, 600 mg compressible sorbitol, 200 mg potassium bicarbonate, 200 mg, titanium dioxide (25%) on a maltodextrin carrier (Food Ingredients Solutions, LLC., Wauwatosa, Wis.), 210 mg corn syrup solids (Maltrin M600), 100 mg sodium carbonate, 100 mg xanthan gum (Keltrol), 60 mg MAG-NIFIQUE mouthfeel powder (Wixon, Inc.), 60 mg MAG-NIFIQUE miner powder (Wixon, Inc.), 50 mg dibasic potassium phosphate, 40 mg functional soy protein (FP 940), 30 mg natural caramel flavor, 30 mg aspartame, and 20 mg soy lecithin.

### Example 2

To 3550 mg base as prepared above in Example 1, the following ingredients were individually sieved through a No. 12 sieve and then combined with the base with mixing until uniform: 350 mg vanilla cream powder and 150 mg PEG 3350 polyethylene glycol.

30 mg canola oil (VEGETOL CVO) and 120 mg hazelnut concentrate was then added to the mixture with mixing continuing until a uniform granulation was achieved.

The composition was then tableted using three sets of one inch stainless steel tools on a rotary tablet press (CadMach, Ahmedabad, India) to a tablet mass of 4.4 g, and a tablet hardness of 11.1 Kp.

The tablets were then placed in ten ounces of hot coffee (having a temperature of approximately 120° F.) and observed to dissolve in one minute and 45 seconds. A creamy beige foam having tight compact bubbles was present on the surface of the dispersion.

### Example 3

To 4220 mg base as prepared above in Example 2, is added 500 mg of sorbitol cubic crystal powder (which had previously been sieved through a No. 12 sieve) with manual mixing until a uniform granulation was achieved.

The composition was then tableted using three sets of one inch stainless steel tools on a rotary tablet press at approximately 25 rpm to an average tablet mass of 5.26 g, an average tablet thickness of 0.278 in., and an average tablet hardness of 7.7 Kp.

No die wall etching was observed on the tablets. No sticking was observed on the faces of the tools.

The tablets were then placed in ten ounces of hot coffee and observed to dissolve in two minutes and 30 seconds. A dense, thin foam having uniform color distribution and free of noticeable titanium dioxide particles was present on the surface of the coffee.

### Example 4

The following ingredients were individually sieved through a number 12 sieve and then combined with mixing for 200 revolutions using a KITCHEN AID mixer until a uniform granulation was achieved. 550 mg calcium carbonate, 700 mg compressible sorbitol, 100 mg potassium bicarbonate, 400 mg MALTRIN M250 corn syrup solids, 200 mg extruded sodium caseinate, 50 mg dibasic potassium phosphate, 100 mg KELTROL TF xanthan gum, 50 mg sodium chloride, 120 mg GRINDSTED MONO-DIHV 52K mixture of mono- and di-glycerides, 40 mg sodium stearoyl lactylate and 20 mg soy lecithin.

To the above mixture was added 700 mg granular citric acid, 600 mg sodium bicarbonate No. 5, 550 mg calcium carbonate, 200 mg potassium bicarbonate, 1500 mg hazelnut flavor, 8 mg acesulfame potassium, 17 mg aspartame, 10 mg chocolate flavor, and 20 mg vanilla flavor and 60 mg MAG-NIFIQUE mouthfeel powder (Wixon, Inc.) with mixing until uniform.

To the above mixture was added 80 mg polysorbate 80 and 40 mg VEGETOL CVO canola oil with mixing until uniform.

To the above mixture was added 90 mg, titanium dioxide (Sensient Technologies Corporation, Milwaukee, Wis.) with mixing until uniform.

The composition was then tableted using three sets of one inch stainless steel tools on a rotary tableting press at approximately 25 rpm to an average tablet mass of 4.12 g, an average tablet thickness of 0.24 in., and an average tablet hardness of 2.18 Kp.

No die wall etching was observed on the tablets. No sticking was observed on the faces of the tools.

When the tablets are placed in ten ounces of hot coffee at approximately 120° F., the tablets are expected to dissolve in from thirty seconds to two minutes. A thick and creamy foam with light brown to dark cream color is expected to be present in the surface of the coffee.

Other embodiments are within the claims. Although the effervescent composition has been described as being in the form of a tablet, the effervescent composition can also granulation), capsule, pellet and composite.

All patents and referenced cited herein are incorporated herein in their entirety. To the extent a conflict exists, the language of the present application governs.

What is claimed is:

1. An effervescent creamer composition comprising:
an effervescent agent comprising an acid and a base;
a pH moderator;
protein;
a mouthfeel agent;
binder; and
lubricant.

2. The effervescent creamer composition of claim 1 wherein said protein comprises soy protein and said composition is free from lactose, casein and caseinate.

3. The effervescent creamer composition of claim 2 further comprising:
titanium dioxide;
polyethylene glycol; and
xanthan gum.

4. The effervescent creamer composition of claim 3, wherein said pH moderator comprises diabasic potassium phosphate.

5. The effervescent creamer composition of claim 3 further comprising at least one of maltodextrin and corn syrup solids.

6. The effervescent creamer composition of claim 2, comprising from about 0.1% by weight to about 10% by weight said soy protein.

7. The effervescent creamer composition of claim 1, further comprising from about 0.5% by weight to about 10% by weight maltodextrin.

8. The effervescent creamer composition of claim 1, further comprising from about 1% by weight to about 10% by weight corn syrup solids.

9. The effervescent creamer composition of claim 1 further comprising at least one of compressible sorbitol and crystalline sorbitol.

10. The effervescent creamer composition of claim 1 further comprising from about 2% by weight to about 25% by weight crystalline sorbitol.

11. The effervescent creamer composition of claim 1 further comprising from about 5% by weight to about 25% by weight compressible sorbitol.

12. The effervescent creamer composition of claim 1, further comprising titanium dioxide.

13. The effervescent creamer composition of claim 1, further comprising from about 0.01% by weight to 5% by weight titanium dioxide.

14. The effervescent creamer composition of claim 1 further comprising lecithin.

15. The effervescent creamer composition of claim 1, further comprising polyethylene glycol.

16. The effervescent creamer composition of claim 1, further comprising from about 0.5% by weight to about 10% by weight polyethylene glycol.

17. The effervescent creamer composition of claim 1, wherein said pH moderator comprises diabasic potassium phosphate.

18. The effervescent creamer composition of claim 17, comprising from about 0.01% by weight to about 4% by weight said dibasic potassium phosphate.

19. The effervescent creamer composition of claim 18 further comprising:
from about 1% by weight to about 20% by weight compressible sorbitol,
from about 2% by weight to about 20% by weight crystalline sorbitol, and
lecithin.

20. The effervescent creamer composition of claim 1, further comprising xanthan gum.

21. The effervescent creamer composition of claim 1, further comprising from about 0.5% by weight to about 5% by weight xanthan gum.

22. The effervescent creamer composition of claim 1, further comprising a flavor agent.

23. The effervescent creamer composition of claim 22, wherein said flavor agent comprises flavor oil.

24. The effervescent creamer composition of claim 23, wherein said flavor agent imparts a flavor selected from the group consisting of chocolate, hazelnut, maple, vanilla, almond, anise, caramel, cream and combinations thereof.

25. The effervescent creamer composition of claim 1 further comprising from about 0.1% by weight to about 10% by weight lecithin.

26. The effervescent creamer composition of claim 1, comprising from about 0.01% b weight to about 15% b weight said mouthfeel agent.

27. The effervescent creamer composition of claim 1, wherein said mouthfeel agent reduces metallic aftertastes.

28. The effervescent creamer composition of claim 1, wherein said mouthfeel agent enhances creaminess perception.

29. The effervescent creamer composition of claim 1, further comprising oil.

30. The effervescent creamer composition of claim 1, further comprising:
maltodextrin;
corn syrup solids;
from about 1% by weight to about 20% by weight compressible sorbitol; and
from about 2% by weight to about 20% by weight crystalline sorbitol.

31. A tablet comprising the effervescent creamer composition of claim 1, said tablet having a hardness of at least 4 kilopounds and a weight from about 3.5 g to about 6 g.

32. The tablet of claim 31 further comprising from about 20 mg to abut 500 mg titanium dioxide.

33. The tablet of claim 31 further comprising from about 25 mg to about 200 mg soy protein.

34. The tablet of claim 31 further comprising from about 5 mg to about 30 mg lecithin.

35. The tablet of claim 31 further comprising from about 1 mg to about 1000 mg crystalline sorbitol.

36. The tablet of claim 31 further comprising from about 200 mg to about 700 mg crystalline sorbitol.

37. The tablet of claim 31, wherein said pH moderator comprises from about 30 mg about 75 mg diabasic potassium phosphate, said protein comprises from about 20 mg to about 30 mg soy protein,
said composition further comprising:
from about 300 mg about 900 mg compressible sorbitol;
from about 300 mg about 900 mg crystalline sorbitol; and
from about 5 mg about 50 mg lecithin.

38. The tablet of claim 31, wherein said tablet disintegrates when added to eight ounces of coffee having a temperature of at least 80° F. and forms a foam on the surface thereof.

39. The tablet of claim 38, wherein said form persists for at least 3 minutes.

40. A method of making a beverage, said method comprising contacting the effervescent creamer composition of claim 1 with coffee having a temperature of at least 80° F.

41. The method of claim 40, further comprising disintegrating said effervescent creamer composition and forming a foam on said coffee.

42. The method of claim 40, further comprising:
disintegrating said effervescent creamer composition; and
whitening said coffee.

43. The method of claim 40, further comprising:
disintegrating said effervescent creamer composition; and
imparting a hazelnut flavor and aroma to said coffee.

44. The effervescent creamer composition of claim 1, wherein said protein comprises at least one of whey protein, milk-based protein, casein and caseinate,
said composition further comprising:
lecithin;
corn syrup solids;
emulsifier;
surfactant;
oil; and
titanium dioxide.

45. The effervescent creamer composition of claim 1 further comprising:
at least one of monoglycerides and triglycerides;
sodium stearolyl lactylate; and
xanthan gum.

46. The effervescent creamer composition of claim 44, wherein said composition disintegrates when added to eight ounces of coffee having a temperature of at least 80° F. and forms a foam on the surface thereof.

47. The effervescent creamer composition of claim 44, wherein said form persists for at least 3 minutes.

48. The effervescent creamer composition of claim 44, wherein said composition disintegrates when added to eight ounces of coffee having a temperature of at least 80° F. and whitens said coffee.
